(19) United States
(12) Patent Application Publication
(10) Pub. No.: US 2017/0168582 A1
(43) Pub. Date: Jun. 15, 2017

(54) CLICK RESPONSE PROCESSING METHOD, ELECTRONIC DEVICE AND SYSTEM FOR MOTION SENSING CONTROL

(71) Applicants: Le Holdings (Beijing) Co., Ltd., Beijing (CN); LE SHI ZHI XIN ELECTRONIC TECHNOLOGY (TIANJIN) LIMITED, Tianjin (CN)

(72) Inventor: Duan Xu, Tianjin (CN)

(21) Appl. No.: 15/249,525

(22) Filed: Aug. 29, 2016

Related U.S. Application Data
(63) Continuation of application No. PCT/CN2016/088311, filed on Jul. 4, 2016.

(30) Foreign Application Priority Data
Dec. 9, 2015 (CN) 201510903724.1

(51) Int. Cl. G06F 3/01; G06F 3/00

(52) U.S. Cl. CPC G06F 3/017; G06F 3/005

(57) ABSTRACT

Embodiments of the present invention disclose a click response processing method for motion sensing control, including: S101: when a push gesture instruction for target content is received, acquiring a transfer point corresponding to the push gesture instruction; S102: triggering a down event corresponding to the push gesture instruction according to the transfer point, and determining and saving information of the transfer point; S103: when a pull gesture instruction is received, directly invoking the information of the transfer point, and triggering an up event corresponding to the pull gesture instruction based on the information of the transfer point; and S104: completing a click event for the target content and outputting a result. Embodiments of the present invention further disclose a electronic device and a motion sensing control system. By means of the embodiments of the present invention, an invalid click event can be prevented from occurring.

### CROSS-REFERENCE TO RELATED APPLICATIONS

The present application is a continuation application of International Application No. PCT/CN2016/088311 filed on Jul. 4, 2016, which claims priority to Chinese Patent Application No. 201510903724.1, titled “CLICK RESPONSE PROCESSING METHOD, ELECTRONIC DEVICE AND SYSTEM FOR MOTION SENSING CONTROL”, filed before China Intellectual Property Office on Dec. 9, 2015, the entire contents of which are incorporated herein by reference.

### TECHNICAL FIELD

The present invention relates to the technical field of motion sensing control, and more particularly, to a click response processing method, electronic device and system for motion sensing control and a motion sensing control system.

### BACKGROUND

By means of motion sensing control, a user interacts with a nearby apparatus or device by using a body motion, to implement a corresponding control function, and the user interacts with content in an immersive manner without needing to use a control device. As shown in FIG. 1, the user stands in front of a display screen, and a motion sensing device (for example, a camera) above the display screen may detect a hand motion of the user. When the user waves a hand upward, downward, leftward, and rightward, the user may control functions of fast-forwarding, rewinding, pausing, and stopping displayed video content, thereby implementing manipulation of a display screen apparatus through motion sensing. There are many similar applications, for example, in a game application, the foregoing four hand motions may correspond to reactions of a game character, so that the user can have immersive gaming experience. Motion sensing control is applicable to technologies such as 3D virtual reality, space mice, game controllers, movement monitoring, and health care.

In a motion sensing control technology, a click event refers to a click of a desktop icon of an apparatus (for example, the display screen in FIG. 1) or an icon in an application by using a body gesture. To complete one click event, a user needs to sequentially make a push gesture and a pull gesture on a target icon. When a camera captures the two gestures sequentially, a down event and an up event in corresponding positions are triggered, respectively, to complete a click event, so as to implement a click of the target icon, thereby achieving convenient manipulation. The click event requires that a distance between gesture points of the down event and the up event should not be excessively long, that is, a stop position of a push and a start position of a pull of a hand of the user need to be within an effective range to implement a click of an icon.

However, because motion sensing control is implemented mainly relying on user gestures, and for user gestures, it is not easy to define standards over motions or amplitudes. Therefore, a click event often becomes invalid. For example, when a user gesture does not meet a standard, a point of an up event may be too far away from a position of a point of a down event, and in this case, the sent up event is invalid. If a point of an up event and/or a point of a down event is too far away from a target icon, the sent up event and/or down event is also invalid; therefore, a valid click event cannot be generated, gestures need to be repeated, and as a result, user experience becomes undesirable.

### SUMMARY

In view of the above, the present invention proposes a click response processing method, electronic device and system for motion sensing control and a motion sensing control system. A transfer point of a down event is used for both a down event and an up event, so that an invalid click event can be prevented from occurring.

An embodiment of the present invention provides a click response processing method for motion sensing control, including: S101: when a push gesture instruction for target content is received, acquiring a transfer point corresponding to the push gesture instruction; S102: triggering a down event corresponding to the push gesture instruction according to the transfer point, and determining and saving information of the transfer point; S103: when a pull gesture instruction is received, directly invoking the information of the transfer point, and triggering an up event corresponding to the pull gesture instruction based on the information of the transfer point; and S104: completing a click event for the target content and output a result.

Preferably, the information of the transfer point includes a position of the transfer point.

Preferably, the information of the transfer point further includes an instruction type corresponding to the transfer point.

Preferably, before S101, the method further includes: recognizing a captured gesture, and when the captured gesture is a push gesture, sending the push gesture instruction.

Preferably, the triggering a down event corresponding to the push gesture instruction according to the transfer point, and determining and saving information of the transfer point includes: when the transfer point triggers the down event corresponding to the push gesture instruction, determining that a transfer point that triggers a down event is the transfer point and saving the information of the transfer point.

Preferably, between S102 and S103, the method further includes: recognizing a captured gesture, and when the captured gesture is a pull gesture, sending the pull gesture instruction.

In another aspect, the embodiments of the present invention provide a nonvolatile computer storage media having computer executable instructions stored thereon, wherein the computer executable instructions are configured to execute any one of the foregoing click response processing method for motion sensing control in the present invention.

In another yet aspect, the embodiments of the present invention provide an electronic device, including: one or more processors; and, a memory; wherein, the memory is stored with instructions executable by the one or more processors, the instructions are configured to execute any one of the foregoing click response processing method for motion sensing control in the present invention.

An embodiment of the present invention further provides a motion sensing control system, including: a camera and a motion sensing control apparatus, where the camera is configured to capture a gesture; and the motion sensing control apparatus includes the foregoing electronic device.

In the embodiments of the present invention, when a down event of a transfer point is triggered, information of the transfer point is also recorded. When an up event needs to be triggered, the information of the transfer point may be directly invoked, and an up event of the transfer point is triggered, to complete a click. Because triggering of a down event and an up event is based on a same transfer point, even if gestures of a user do not meet standards during motion sensing control and a case, among others, in which a distance between a pull gesture and a push gesture is excessively long occurs, a click can still be completed in time and accurately, thereby preventing an invalid click event from occurring and improving the accuracy of a click, and improving user experience.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise.

FIG. 1 is a schematic diagram of gesture capture of motion sensing control;

FIG. 2 is a flowchart of a click response processing method for motion sensing control according to an embodiment of the present invention;

FIG. 3 is a flowchart of a click response processing method for motion sensing control according to another embodiment of the present invention;

FIG. 4 is a structural block diagram of a click response process apparatus for motion sensing control according to an embodiment of the present invention;

FIG. 5 is a schematic diagram of a structure of an hardware of the electronic device of the click response processing method for motion sensing control according to further another embodiment of the present invention; and

FIG. 6 is a structural block diagram of a motion sensing control system according to an embodiment of the present invention.

### DETAILED DESCRIPTION

The technical solutions of the present invention are described below in detail with reference to the accompanying drawings and specific embodiments.

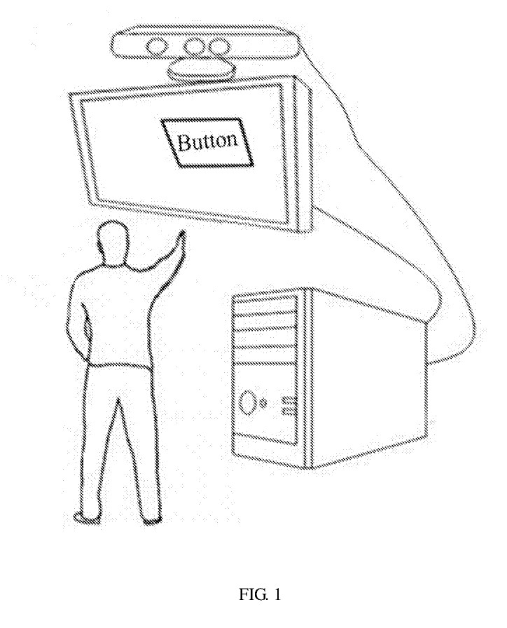

FIG. 1 is a schematic diagram illustrating gesture capture of motion sensing control. A user stands in front of a display screen and a camera of a motion sensing control system, and the camera collects a body gesture made by the user toward the display screen, where a push gesture triggers a down event, a pull gesture triggers an up event, and the down event and the up event form a click event.

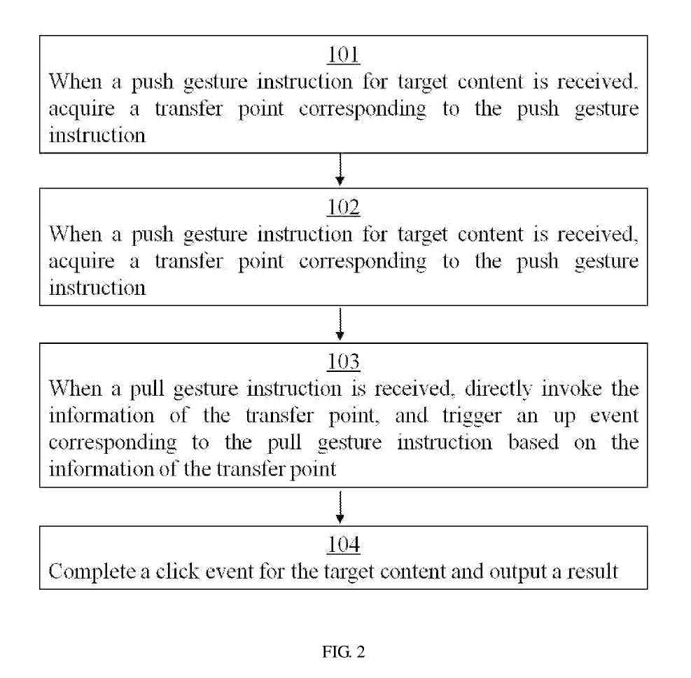

FIG. 2 is a flow chart illustrating a click response processing method for motion sensing control according to an embodiment of the present invention, where the method includes the following steps:

S101: When a push gesture instruction for target content is received, a transfer point corresponding to the push gesture instruction is acquired.

S102: A down event corresponding to the push gesture instruction is triggered according to the transfer point, and information of the transfer point is determined and saved.

S103: When a pull gesture instruction is received, the information of the transfer point is directly invoked, and an up event corresponding to the pull gesture instruction is triggered based on the information of the transfer point.

S104: A click event for the target content is completed and a result is output.

Compared with a prior solution in which two transfer points need to be acquired to complete a click event, in this embodiment of the present invention, a mechanism of triggering a corresponding event based on the transfer points is optimized. A push gesture is used to obtain a down event transfer point to trigger a down event, and information of the down event transfer point is saved. Subsequently, when an up event is triggered, a saved transfer point may be directly invoked and a position of a pull gesture no longer needs to be considered. It can be seen that by means of this embodiment of the present invention, only one transfer point needs to be marked to trigger a down event and an up event and there is no longer a distance or range limitation; therefore, an invalid click event can be prevented from occurring, thereby improving the accuracy of clicking target content.

In this embodiment of the present invention, to meet a condition required to trigger an up event after a down event, the information of the transfer point should include at least a position of the transfer point.

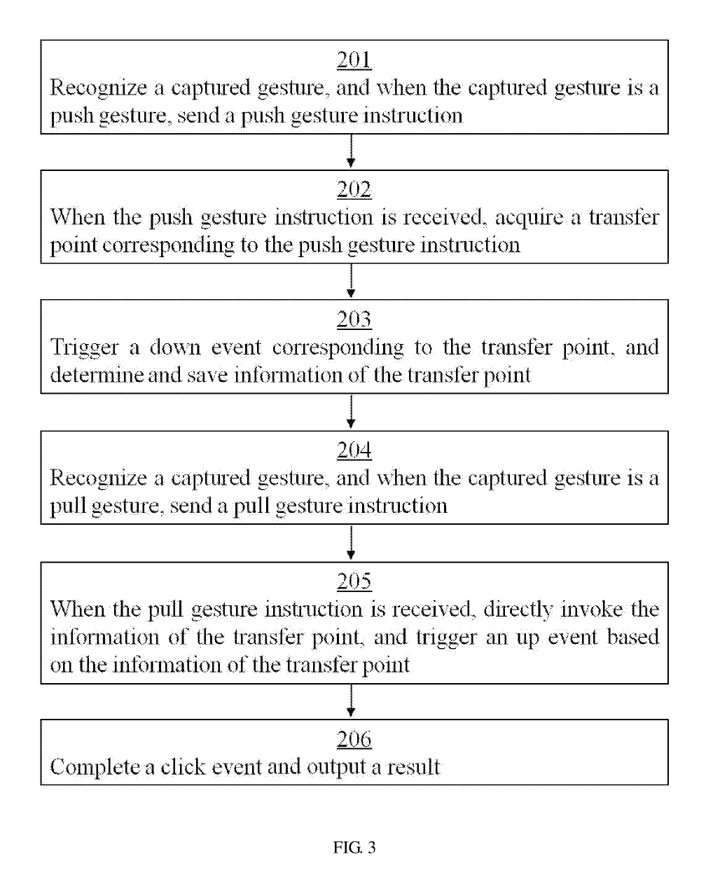

In an actual application scenario, as shown in FIG. 1, a user stands in front of a display screen and a camera of a motion sensing control system, and the camera collects a body gesture made by the user toward the display screen, where a push gesture triggers a down event, a pull gesture triggers an up event, and the down event and the up event form a click event. In this embodiment of the present invention, the motion sensing control system recognizes the body gesture captured by the camera. A processing process is described below by using an example in which the user clicks an icon on a desktop of the display screen by using a body gesture, and referring to FIG. 3, the processing process is specifically as follows:

S201: The motion sensing control system recognizes a gesture according to an image collected by a camera, and if the gesture is recognized as a push gesture, sends a push gesture instruction, where target content of the push gesture is an icon that the user wants to click.

S202: When the push gesture instruction is received, a transfer point corresponding to the push gesture instruction on a display screen is acquired.

S203: A down event corresponding to the transfer point is triggered, and at the same time information of the transfer point is determined and saved, where the information includes at least a position of the transfer point, and may further include an instruction type corresponding to the transfer point.

The position of the transfer point is: a position of a point at which the push gesture points when the push gesture of the user has the shortest distance to the display screen. When the transfer point triggers the down event corresponding to the push gesture instruction, it is determined that a transfer point that triggers a down event is the transfer point and the information of the transfer point is saved. Specifically, when the user makes a body gesture, the body gesture collected by the camera is a series of movement curves. When the push gesture is completed, a movement curve L of the push gesture no longer changes, a point A having the shortest distance from the surface of the display screen is found from the movement curve L, and a point B that is in a same horizontal line of the point A and is on the display screen is a point at which the push gesture points. It may be understood that a position of the point B should fall inside a range of the icon that the user wants to click. The position of the point B is the position of the transfer point, and the position of the point B is recorded, so that the position of the point B is easily invoked for a subsequent up event.

In addition, in this embodiment of the present invention, the information of the transfer point may further include an instruction type corresponding to the transfer point. For example, in the embodiment in FIG. 3, the instruction type corresponding to the transfer point is an instruction type “push gesture”. According to this, the system may acquire a type of an event executed at a different moment.

S204: The motion sensing control system continues to recognize a captured gesture, and when a pull gesture is captured, send a pull gesture instruction.

S205: When the pull gesture instruction is received, the saved information of the transfer point is directly invoked, and an up event is triggered based on the information of the transfer point.

S206: The down event and the up event of the transfer point form a click event, so that a click of a target icon is implemented, and a result that the target icon is chosen is output.

In this embodiment of the present invention, a transfer point of a pull gesture does not need to be recorded, and the transfer point of the pull gesture is also not used to trigger an up event. Instead, a down event and an up event are triggered based on a same transfer point (a transfer point of a push gesture), to complete a click of a target content, so that a user may perform a gesture operation in a next step.

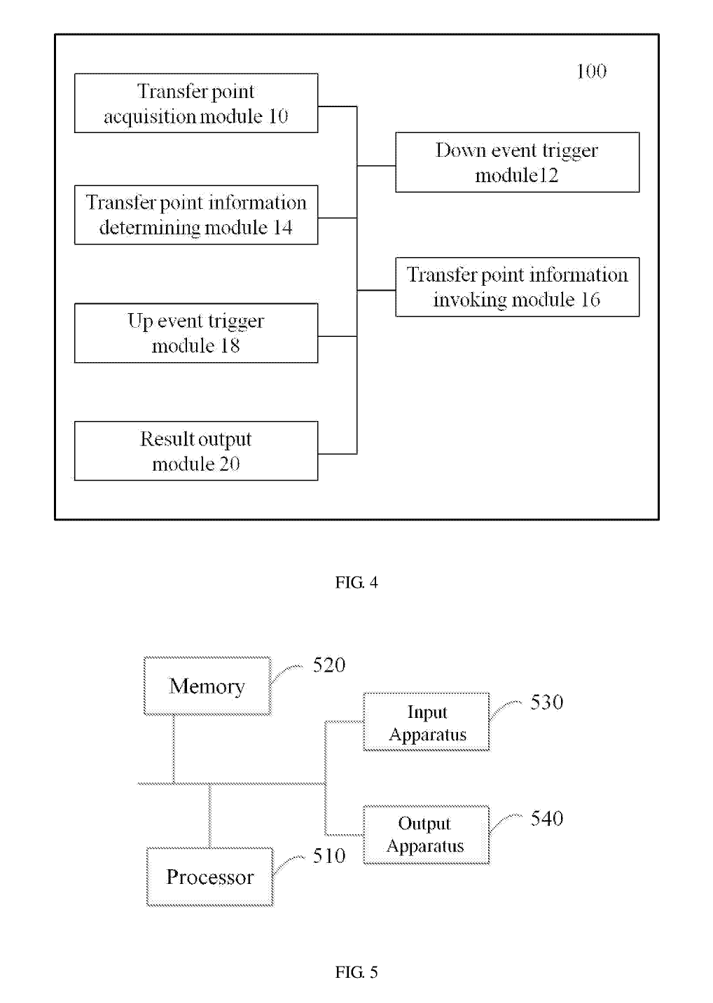

Corresponding to a processing procedure in this embodiment of the present invention, an embodiment of the present invention further provides a click response process apparatus 100 for motion sensing control. As shown in FIG. 4, the apparatus includes:

a transfer point acquisition module 10, configured to: when a push gesture instruction for target content is received, acquire a transfer point corresponding to the push gesture instruction;

a down event trigger module 12, configured to trigger a down event corresponding to the push gesture instruction according to the transfer point;

a transfer point information determining module 14, configured to determine and save information of the transfer point;

a transfer point information invoking module 16, configured to: when a pull gesture instruction is received, directly invoke the information of the transfer point;

an up event trigger module 18, configured to trigger an up event corresponding to the pull gesture instruction based on the information of the transfer point; and

a result output module 20, configured to complete a click event for the target content and output a result.

Further, the apparatus 100 in the embodiment in FIG. 4 may further include a push gesture recognition processing module, configured to recognize a captured gesture, and when the captured gesture is a push gesture, send the push gesture instruction to the transfer point acquisition module.

Further, the apparatus 100 in the embodiment in FIG. 4 may further include a pull gesture recognition processing module, configured to recognize a captured gesture, and when the captured gesture is a pull gesture, send the pull gesture instruction to the transfer point information invoking module.

The embodiments of the present invention provide a nonvolatile computer storage media having computer executable instructions stored thereon, wherein the computer executable instructions are configured to execute the click response processing method for motion sensing control in any one of the foregoing embodiments of methods.

FIG. 5 is a schematic diagram of a structure of an hardware of the electronic device of the a click response processing method for motion sensing control according to an embodiment of the present invention, as shown in FIG. 5, the device includes:

one or more processors 510 and a memory 520, in FIG. 5, one processor 510 is employed as an example.

The device of the click response processing method for motion sensing control may further includes: an input apparatus 530 and an output apparatus 540.

The processor 510, the memory 520, the input apparatus 530 and the output apparatus 540 may be connected via a bus or other means, in FIG. 5, a connection via a bus is taken as an example.

As a nonvolatile computer readable storage media, the memory 520 can be used to store nonvolatile software program, nonvolatile computer executable program and module, such as the program instructions/modules corresponding to a click response processing method for motion sensing control in the embodiments of the present application (e.g., the transfer point acquisition module 10, and the result output module 20 as shown in FIG. 4). The processor 510 executes various functions and applications of a server and data processing by running a nonvolatile software program, instructions and a module stored in the memory 520, so as to carry out the click response processing method for motion sensing control in the embodiments above.

The memory 520 may include a program storage area and a data storage area, wherein the program storage area can store an operating system, an application program required for at least one function; the data storage area can store the data created based on the use of a click response processing device for motion sensing control, or the like. Further, the memory 520 may include high-speed random access memory, and may further include nonvolatile memory, such as at least one disk storage device, flash memory device, or other nonvolatile solid-state memory devices. In some embodiments, the memory 520 optionally includes a memory remotely located with respect to the processor 510, which may be connected to the click response processing device for motion sensing control via a network. Examples of such network include, but not limited to, Internet, Intranet, local area network (LAN), mobile communication network, and combinations thereof.

The input apparatus 530 may receive the input numbers or characters information, as well as key signal input associated with user settings of the click response processing device for motion sensing control and function control. The output apparatus 540 may include a display screen or other display device.

The one or more modules are stored in the memory 520, and when being executed by the one or more processors 510, execute the click response processing method for motion sensing control to any one of the foregoing embodiments of methods.

The above mentioned products can perform the method provided by the embodiments of the present application, and they have the function modules and beneficial effects corresponding to this method. With respect to the technical details that are not detailed in this embodiment, please refer to the methods provided by the embodiments of the present application.

The electronic device according to the embodiments of the present application may have many forms, for example, including, but not limited to:

(1) mobile communication device: the characteristic of such device is: it has the function of mobile communication, and takes providing voice and data communications as the main target. Such type of terminal includes: smart phones (for example iPhone), multimedia phones, feature phones and low-end mobile phones.

(2) ultra mobile PC device: this type of device belongs to the category of personal computer, it has the capabilities of computing and processing, and generally has the feature of mobile Internet access. Such type of terminal includes: PDA, MID and UMPC devices.

(3) portable entertainment device: this type of device can display and play multimedia content. Such type of device includes: audio players (for example iPod), video players, handheld game consoles, e-books, as well as smart toys and portable vehicle navigation devices.

(4) server: it provides computing services, and the structure of the server includes: a processor, a hard disk, a memory, a system bus and the like, its construction is similar to a general computer, but there is higher requirement on the processing capability, stability, reliability, security, scalability, manageability and other aspects of the server as highly reliable service is needed to provide.

(5) other electronic device that has the function of data exchange.

The apparatus of the above described embodiments are merely illustrative, and the unit described as separating member may or may not be physically separated, the component shown as a unit may be or may not be a physical unit, i.e., it may be located at one place, or it can be distributed to a plurality of network units. The aim of this embodiment can be implemented by selecting a part of or all of the modules according to the practical needs. And it can be understood and implemented by those of ordinary skill in the art without paying any creative work.

With reference to the above described embodiments, those skilled in the art can clearly understand that all the embodiments may be implemented by means of using software plus a necessary universal hardware platform, of course, they also be implemented by hardware. Based on this understanding, the above technical solution can be substantially, or the part thereof contributing to the prior art may be, embodied in the form of a software product, and the computer software product may be stored in a computer readable storage medium, such as ROM/RAM, magnetic disc, CD-ROM, or the like, which includes several instructions to instruct a computer device (may be a personal computer, server, or network equipment) to perform the method described in each embodiment or some parts of the embodiment.

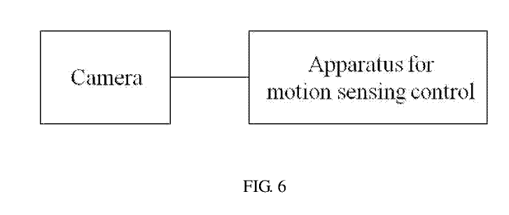

In addition, an embodiment of the present invention further provides a motion sensing control system. As shown in FIG. 6, the system includes a camera and a motion sensing control apparatus, wherein the camera captures a gesture, and the motion sensing control apparatus includes an electronic device. The electronic device recognizes the captured gesture. When the captured gesture is recognized as a push gesture, the electronic device acquires a transfer point of the push gesture, triggers a down event of the push gesture, determines and saves information of the transfer point, and recognizes a pull gesture, and sends a pull gesture instruction. After receiving the pull gesture instruction, the electronic device directly invokes the information of the transfer point, and triggers an up event of the pull gesture instruction, to complete implementation of a click of target content.

The motion sensing control system uses a transfer point of a down event for both a transfer point that triggers a down event and a transfer point that triggers an up event, so that an invalid click event caused by that trigger points of a down event and an up event do not match in the prior art is prevented from occurring, thereby improving the accuracy of clicking icon content.

Finally, it should be noted that: the above embodiments are merely provided for describing the technical solutions of the present invention, but not intended to limit thereto; although the present invention has been described in detail with reference to the foregoing embodiments, those skilled in the art will appreciate that: they can make modifications to the technical solutions described in the foregoing embodiments, or make equivalent replacements to some technical features thereof; and these modifications or replacements do not make the essence of corresponding technical solutions depart from the spirit and scope of the technical solution of each embodiment.

What is claimed is:

1. A click response processing method for motion sensing control, which is applied to terminal, comprising:
S101: when a push gesture instruction for target content is received, acquiring a transfer point corresponding to the push gesture instruction;
S102: triggering a down event corresponding to the push gesture instruction according to the transfer point, and determining and saving information of the transfer point;
S103: when a pull gesture instruction is received, directly invoking the information of the transfer point, and triggering an up event corresponding to the pull gesture instruction based on the information of the transfer point; and
S104: completing a click event for the target content and outputting a result.

2. The click response processing method for motion sensing control according to claim 1, wherein the information of the transfer point comprises a position of the transfer point.

3. The click response processing method for motion sensing control according to claim 2, wherein the information of the transfer point further comprises an instruction type corresponding to the transfer point.

4. The click response processing method for motion sensing control according to claim 1, wherein before S101, the method further comprises:
recognizing a captured gesture, and when the captured gesture is a push gesture, sending the push gesture instruction.

5. The click response processing method for motion sensing control according to claim 4, wherein the triggering a down event corresponding to the push gesture instruction according to the transfer point, and determining and saving information of the transfer point comprises:
when the transfer point triggers the down event corresponding to the push gesture instruction, determining that a transfer point that triggers a down event is the transfer point and saving the information of the transfer point.

6. The click response processing method for motion sensing control according to claim 1, wherein between S102 and S103, the method further comprises:
recognizing a captured gesture, and when the captured gesture is a pull gesture, sending the pull gesture instruction.

7. A nonvolatile computer storage media, which has computer executable instructions stored thereon, wherein the computer executable instructions are configured to:
S101: when a push gesture instruction for target content is received, acquire a transfer point corresponding to the push gesture instruction;
S102: trigger a down event corresponding to the push gesture instruction according to the transfer point, and determining and saving information of the transfer point;
S103: when a pull gesture instruction is received, directly invoke the information of the transfer point, and trigger an up event corresponding to the pull gesture instruction based on the information of the transfer point; and
S104: complete a click event for the target content and outputting a result.

8. The nonvolatile computer storage media according to claim 7, wherein the information of the transfer point comprises a position of the transfer point.

9. The nonvolatile computer storage media according to claim 8, wherein the information of the transfer point further comprises an instruction type corresponding to the transfer point.

10. The nonvolatile computer storage media according to claim 7, wherein before S101, the method further comprises:
recognizing a captured gesture, and when the captured gesture is a push gesture, sending the push gesture instruction.

11. The nonvolatile computer storage media according to claim 10, wherein the triggering a down event corresponding to the push gesture instruction according to the transfer point, and determining and saving information of the transfer point comprises:
when the transfer point triggers the down event corresponding to the push gesture instruction, determining that a transfer point that triggers a down event is the transfer point and saving the information of the transfer point.

12. The nonvolatile computer storage media according to claim 7, wherein between S102 and S103, the method further comprises:
recognizing a captured gesture, and when the captured gesture is a pull gesture, sending the pull gesture instruction.

13. An electronic device, comprising:
one or more processors; and
a memory; wherein,
the memory is stored with instructions executable by the one or more processors, the instructions are configured to execute:
S101: when a push gesture instruction for target content is received, acquiring a transfer point corresponding to the push gesture instruction;
S102: triggering a down event corresponding to the push gesture instruction according to the transfer point, and determining and saving information of the transfer point;
S103: when a pull gesture instruction is received, directly invoking the information of the transfer point, and triggering an up event corresponding to the pull gesture instruction based on the information of the transfer point; and
S104: completing a click event for the target content and outputting a result.

14. The electronic device according to claim 13, wherein the information of the transfer point comprises a position of the transfer point.

15. The electronic device according to claim 14, wherein the information of the transfer point further comprises an instruction type corresponding to the transfer point.

16. The electronic device according to claim 13, wherein before S101, the method further comprises:
recognizing a captured gesture, and when the captured gesture is a push gesture, sending the push gesture instruction.

17. The electronic device according to claim 16, wherein the triggering a down event corresponding to the push gesture instruction according to the transfer point, and determining and saving information of the transfer point comprises:
when the transfer point triggers the down event corresponding to the push gesture instruction, determining that a transfer point that triggers a down event is the transfer point and saving the information of the transfer point.

18. The electronic device according to claim 13, wherein between S102 and S103, the method further comprises:
recognizing a captured gesture, and when the captured gesture is a pull gesture, sending the pull gesture instruction.
